(19) United States
(12) Patent Application Publication
(10) Pub. No.: US 2014/0316862 A1
(43) Pub. Date: Oct. 23, 2014

(54) PREDICTING CUSTOMER SATISFACTION

(71) Applicants: Geetha Panda, Bangalore Karnataka (IN); Amol Ashok Kapse, Mumbai (IN); Anand Kumar Mecheri, Bangalore Karnataka (IN)

(72) Inventors: Geetha Panda, Bangalore Karnataka (IN); Amol Ashok Kapse, Mumbai (IN); Anand Kumar Mecheri, Bangalore Karnataka (IN)

(73) Assignee: HEWLETT-PACKARD DEVELOPMENT COMAPNY, L.P., Houston, TX (US)

(21) Appl. No.: 14/346,344

(22) PCT Filed: Oct. 14, 2011
(86) PCT No.: PCT/US2011/056426

§ 371 Date: Mar. 21, 2014

(51) Int. Cl. G06Q 10/06; G06Q 30/00

(52) U.S. Cl. CPC G06Q 10/06393; G06Q 30/01
USPC 705/7.39

(57) ABSTRACT

Systems and methods for predicting customer satisfaction are disclosed. An example method includes identifying business factors related to customer satisfaction. The method also includes translating the business factors to measurable metrics. The method also includes predicting for a user, variations in performance leading to lower customer satisfaction, based on the measurable metrics.

### BACKGROUND

Customer service remains a high priority for most organizations providing products and/or services. Ongoing complaints can result in customers taking their business to competitors. In the age of instant communication via the Internet and social media, negative publicity can quickly lead to the downfall of an organization that fails to take corrective action in a timely manner.

Many organizations track overall customer satisfaction on a fairly regular basis, but the response is typically retroactive. That is, many organizations ask their customers to complete a traditional survey after making a purchase or having interacted with the organization, asking for customer opinions of particular transactions (e.g., the sales experience, or the quality of technical support). The survey is intended to gauge the customers overall satisfaction with a product and/or delivery of a service (including technical support for a product). The survey may also inquire how the organization might improve the customer experience in the future. The collected surveys are generally manually scanned to identify problems so that corrective action can be taken to improve customer experience in the future.

Customer satisfaction may also be reported by customer service representatives who are actually interfacing with the customers. For example, if a customer service representative notices that the customers are consistently lodging complaints about a particular aspect of a product and/or delivery of a service, then the customer service representative may notify their management. The appropriate person in the management chain may determine whether corrective action should be taken to improve the customer experience in the future. But often by the time corrective action is taken, it is too late to prevent customer dissatisfaction which can lead to negative publicity.

### BRIEF DESCRIPTION OF THE DRAWINGS

FIG. 1 is a high-level illustration of an example networked computer system which may be implemented for predicting customer satisfaction.

FIG. 2 is a high-level process diagram illustrating an example model for predicting customer satisfaction.

FIG. 3 shows example correlation between customer satisfaction and attribute questions.

FIG. 4 shows an example association of L3 attributes and L4 metrics.

FIGS. 5a-c illustrate predicting L3 attributes based on L4 metrics.

FIG. 6 is a plot showing the prediction of overall customer satisfaction.

FIG. 7 is a flowchart illustrating example operations which may be implemented for predicting customer satisfaction.

### DETAILED DESCRIPTION

Customer service is a high priority for most organizations. But to the extent organizations track customer satisfaction, the response is typically retroactive. Systems and methods for predicting customer satisfaction are disclosed, which may be implemented to address potential areas of concern in advance of an actual problem.

An example system for predicting customer satisfaction includes machine readable instructions stored an a computer readable medium and executed by a processor to identify operational variables or business factors related to customer satisfaction. The business factors may be translated to measurable metrics. For example, metrics may be measured using customer feedback or survey data. The system may output predictions of variations in performance which could lead to lower customer satisfaction if not addressed in a timely manner, based on the measurable metrics.

The system may further analyze both transactional attributes and operational metrics. Transactional attributes are those involving a particular interaction with a customer, such as the time it takes a customer to reach the service desk, the appropriateness and/or accuracy of the solution, and the agent's ability to understand the issue. Operational metrics are those involving internal operations, such as the number of tickets which remain open after 5 days, the analysts knowledge or skill level, the analysts ability to resolve the issue, and the average time to handle an issue.

The system may also correlate transactional attributes and operational metrics to identify an association between the transactional attributes and operational metrics. The system may also predict transactional attributes based on the operational metrics. The business factors may be assessed, and recalibrated over time to help ensure that the appropriate metrics are being monitored which enable assessment of the customer service experience.

The systems and methods described herein may be used for generating an alert as part of a corrective action plan, in advance of a measured negative impact on customer satisfaction. For example, the corrective action plan may be automatically established if the variations in performance exceed a threshold. In addition, a process control may be implemented as part of the corrective action plan to help ensure that customer satisfaction is not adversely affected again in the same or similar manner in the future.

Before continuing, it is noted that as used herein, the terms “includes” and “including” mean, but is not limited to, “includes” or “including” and “includes at least” or “including at least.” The term “based on” means “based on” and “based at least in part on.”

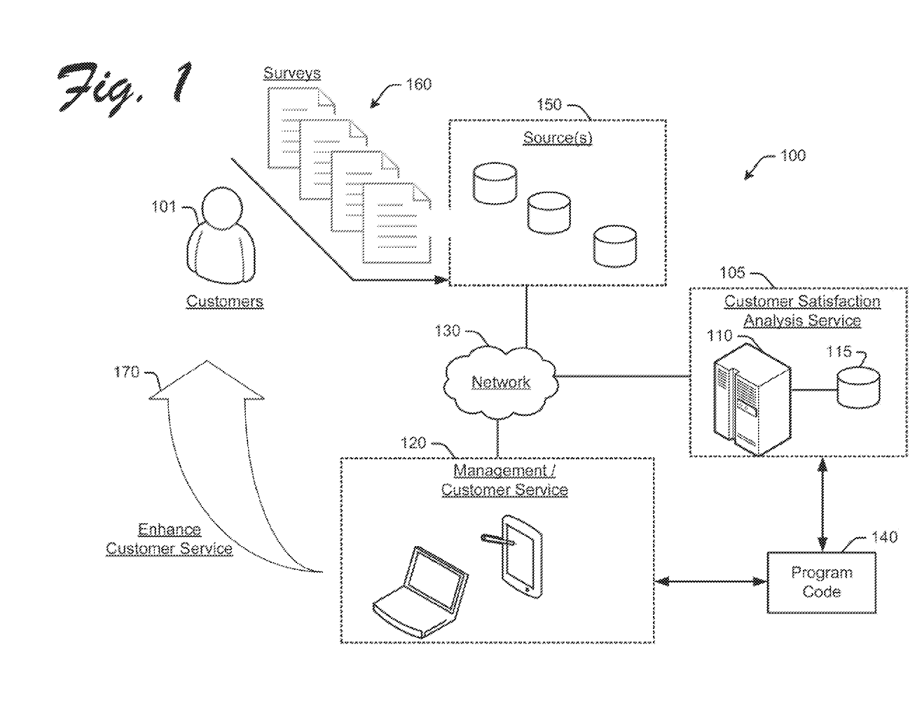

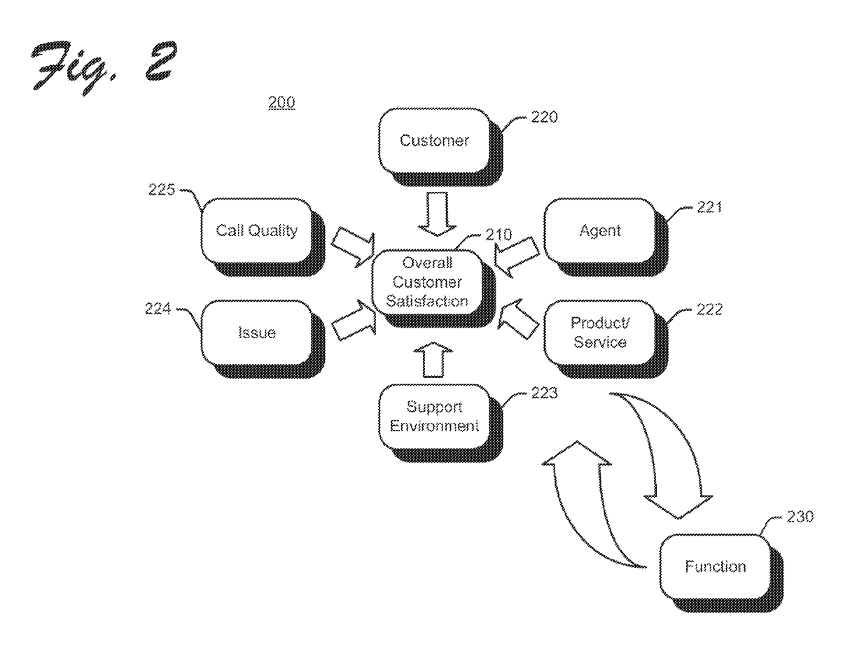

FIG. 1 is a high-level block diagram of an example networked computer system which may be implemented for predicting customer satisfaction. System 100 may be implemented with any of a wide variety of computing devices, such as, but not limited to, consumer computing devices, mobile devices, workstations, and server computers, to name only a few examples. The computing devices may include memory, storage, network connectivity, and a degree of data processing capability sufficient to execute the program code described herein. In an example, the system 100 may include a host 110 providing a service 105 accessed by management and/or the appropriate customer service entity via a client device 120.

Before continuing, it is noted that the computing devices are not limited in function. The computing devices may also provide other services in the system 100. For example, host 110 may also provide transaction processing services for the client 120.

The system 100 may also include a communication network 130, such as a local area network (LAN) aridity wide area network (WAN). In one example, the network 130 includes the Internet or other communications network (e.g., a mobile device network). Network 130 may provide greater accessibility to the service 105 for use in distributed environments, for example, where more than one user may have input and/or receive output from the service 105.

In an example, the service 105 may be a customer satisfaction analysis service executing on host 110 configured as a server computer with computer-readable storage 115. The service 105 may include the program code 140 implementing user interfaces to application programming interfaces (APIs), and the related support infrastructure which may be the exclusive domain of desktop and local area network computing systems, and/or hosted business services.

The service 105 may be accessed by the client 120 in the networked computer system 100. For example, the service 105 may be a cloud-based service, wherein the program code is executed on at least one computing device local to the client 120, but having access to the service 105 in the cloud computing system.

During operation, the service 105 may have access to at least one source 150 of information or data. The source 150 may be local to the service 105 and/or physically distributed in the network 130 and operatively associated with the service 105. in an example, source 150 includes information related to business support parameters for an enterprise.

The source 150 may include databases storing information provided by customer surveys 160. For example, the customer surveys may be submitted by customer 165 online, during a phone survey, or in more traditional “hand-written” formats. Example survey information is described in more detail below for purposes of illustration. However, there is no limit to the type or amount of information that may be provided by the source. In addition, the information may include unprocessed or “raw” data, and/or the information may undergo at least some level of processing.

As mentioned above, the program code 140 may be executed by any suitable computing device for predicting customer satisfaction.

In en example, the program code 140 may include machine readable instructions, which may be executed for predicting customer satisfaction. The machine-readable instructions may be stored on a non-transient computer readable medium 115 and are executable by one or more processor (e.g., by the host 110) to perform the operations described herein. The program code may execute the function of the architecture of machine readable instructions as self-contained modules.

These modules can be integrated within a self-standing tool, or may be implemented as averts that run on top of an existing program code. In any event, the output may be used by management and/or the appropriate customer service entity for an enterprise, so that action can be taken to enhance the customer service experience, as illustrated in FIG. 1 by arrow 170. Predicting customer satisfaction with product(s) and/or service(s) enables an enterprise to be proactive without having to be corrective or retroactive in addressing issues that could result in lower customer satisfaction.

Example operations executed by the program code 140 for predicting customer satisfaction will be described in more detail below for purposes of illustration. It is noted, however, that the components and program code architecture described above are only for purposes of illustration of an example operating environment. The operations described herein are not limited to any specific implementation with any particular type of program code.

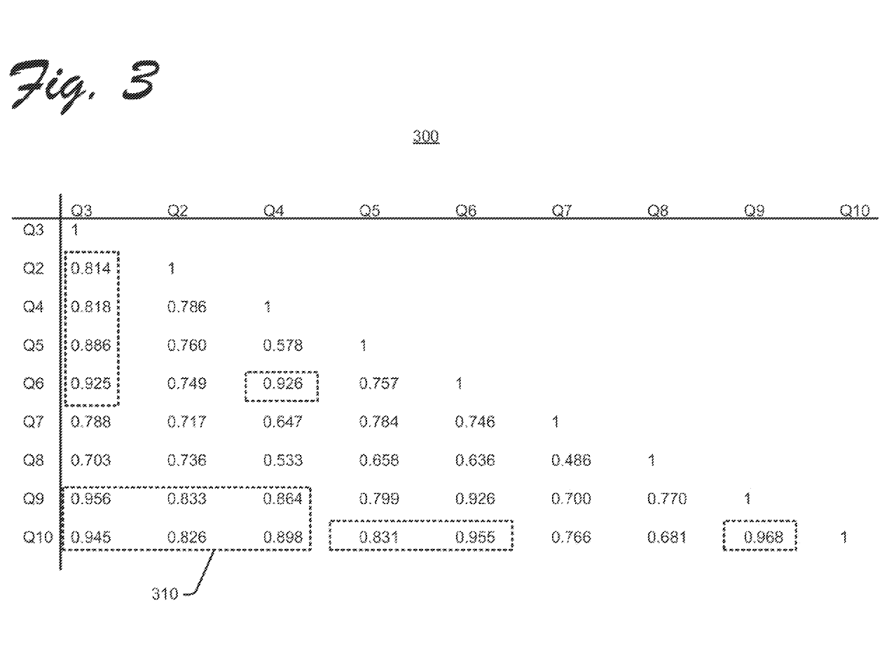

FIG. 2 is a high-level process diagram illustrating an example model 200 for predicting customer satisfaction 210. A number of business factors 220-225 are shown as these may be used to monitor and feed into the overall customer satisfaction component 210. Continuing with the example of a customer support call center providing technical assistance, some example business factors may include, but are not limited to, a customer component 220, a support agent component 221 a product/service component 222, a support environment component 223, a call issue component 224, and a call quality component 225.

These components 220-225 may each include at number of variables that affect overall customer satisfaction. Example variables include, but are not limited to, the technical savvy and qualifications/experience of the call center agent, support expectations of the customer, training and learning ability of the support agent, product complexity, number of issues handled by the rail center agent, and whether the product or service for which technical service is being provided is new to the marketplace, changes in the support environment (e.g., attrition and management changes, and business process changes), issue complexity, and queue wait time for responding to calls.

The business factors 220-225 may be translated to measurable metrics. Measurable metrics may be represented mathematically by an example expression 230 as follows:

[symbol]

=f(x)+c

In the above expression 230, [symbol] represents an overall customer satisfaction score, f(x) represents measureable metrics, and c is a constant. The constant may be used to represent other (e.g., unexplained) business factors. The analysis described herein may then be used to determine which x influences [symbol] , and to describe mathematically, the overall customer satisfaction to the greatest extent possible. This may be accomplished using actual customer data gathered using surveys.

In an example, surveys may be classified using four levels. A first survey may be used to measure Level 1 (L1) variables, L1 variables may include data describing end-to-end customer experience. The L1 survey may be used to determine how the organization is doing in relation to competitor(s). The L1 survey may include questions in two categories, including a) business-to-business, and b) business-to-consumer. In an example, the L1 survey may be utilized on an annual or semiannual basis.

A second survey may be used to measure Level 2 (L2) variables. L2 variables may include data describing a category or Recycle phase experience. The L2 survey may be used to achieve a better understanding of a phase of the customer lifecycle. In an example, the L2 survey may be utilized on an as needed basis.

A third survey may be used to measure Level 3 (L3) variables. L3 variables describe event or transactional attributes. The L3 survey may be used for rapid problem resolution and/or diagnosis during a particular customer engagement that is triggered by an event or transaction. In an example, the L3 survey may be utilized on an ongoing basis.

A fourth survey may be used to measure Level 4 (L4) variables. L4 variables describe operational metrics. The L4 survey may be used to gather ongoing data for internal processes that directly impact the customer experience. In an example, the L4 survey may be utilized on an ongoing basis.

According to this hierarchy, parameters describing the L3 attributes and L4 metrics may be used for predicting customer satisfaction. It is noted, however, that the survey levels described above are for purposes of illustration only, and are not intended to be limiting. Nor are the designators L1-L4 intended to be limiting. Any suitable designator may be used.

FIG. 3 shows an example correlation between customer satisfaction and the customer survey questions. In this example, the attribute questions (Q) are from a survey used for a phone support center, and include: Q2—whether the issue was resolved; Q3—overall customer satisfaction Q4—number of contacts to resolve the issue; Q5—time to contact the service desk; Q6—the agent's understanding of the issue; Q7—communication skills; Q8—courtesy and commitment; Q9—appropriateness and/or accuracy of the solution; and Q10—timeliness of the resolution. It is noted in this example that Q3 asks the customer to rank theft overall customer satisfaction. Hence, information for the other questions (Q2 and Q4-Q10) are compared to the information for Q3.

Correlation coefficients are shown in FIG. 3. A correlation coefficient of 1 means there is a strong correlation, while 0 indicates a weak or no correlation, it can be seen by the correlations shown in FIG. 3, that attributes having the most significant impact on customer satisfaction (e.g., as illustrated by boxes 310) include: whether the issue was resolved, number of contacts to resolve the issue, time to contact the service desk, understanding of the issue, appropriateness and/or accuracy of the solution, and timeliness of resolution.

By applying post multi-collinearity analysis to these results, the most significant attributes (e.g., “short-listed” attributes) include: Q5—time to contact the service desk, Q6—understanding of the issue, and Q9—appropriateness and/or accuracy of the solution.

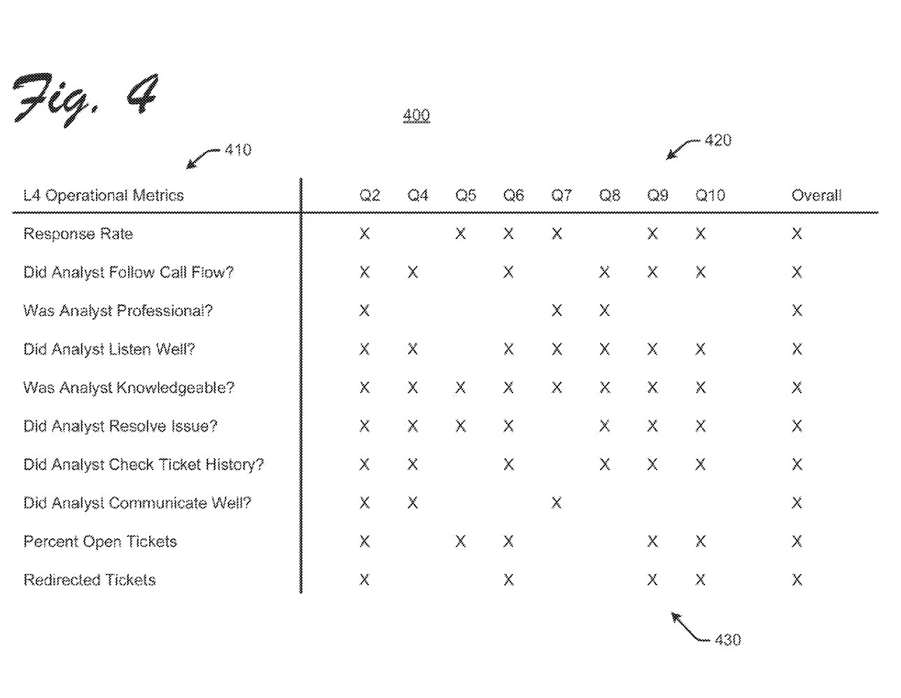

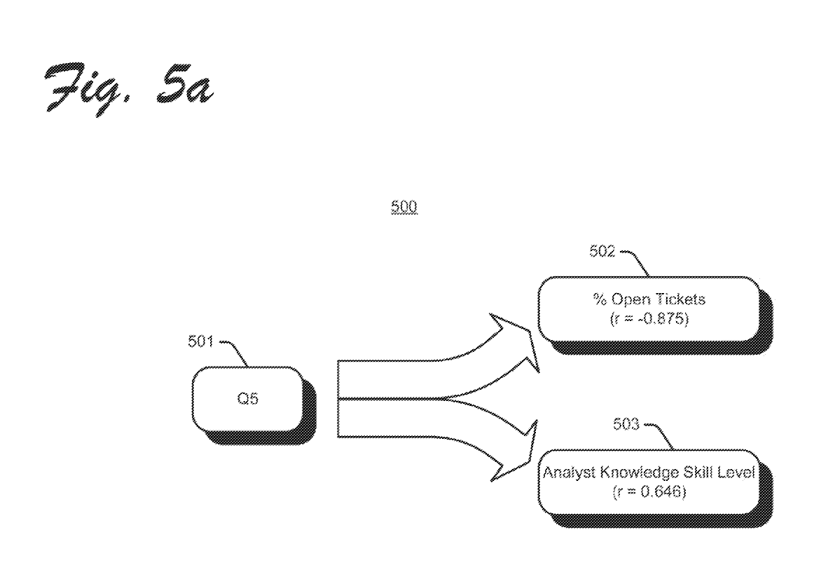

In addition, operational metrics from the L4 survey may be associated with the transactional attributes from the L3 survey. FIG. 4 shows an example association. This association enables identification of operational metrics from the L4 survey which have the greatest impact on overall customer satisfaction. In FIG. 4, an “x” in the table indicates an association between operational metrics in column 410 and transactional attributes shown in columns 420.

Transactional attributes may now be predicted based on operational metrics using statistical algorithms and the established relationship between L3 and L4 survey information. In an example, the analysis includes predicting overall customer satisfaction by regression analysis.

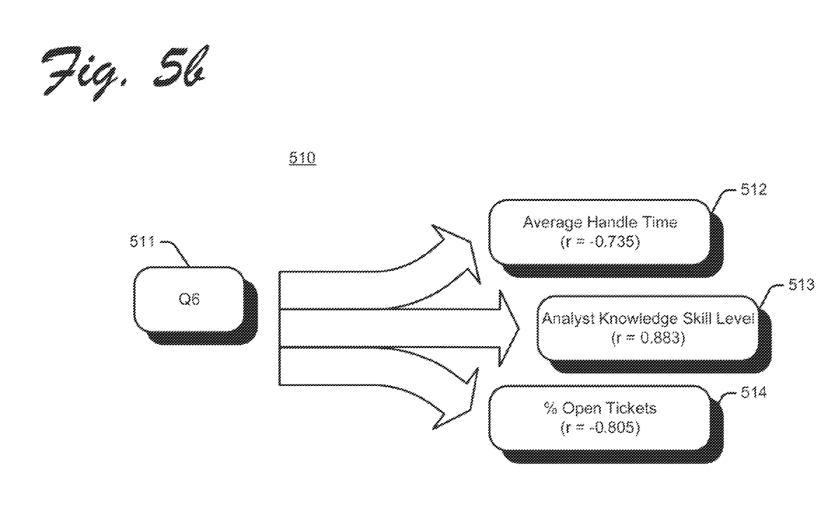

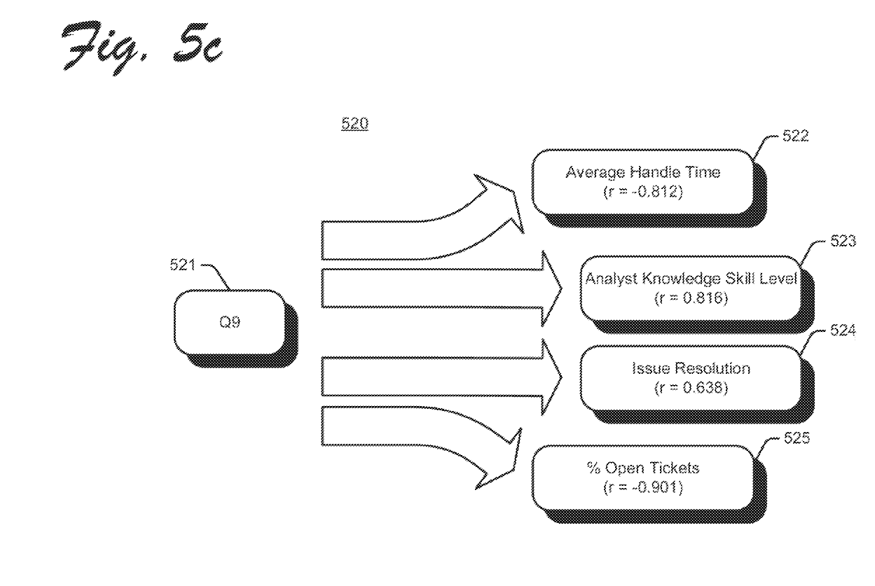

FIGS. 5a-c illustrate predicting transactional attributes based on operational metrics. FIG. 5a shows a prediction 500 of the transactional metric 501 (Q5—time to contact service desk) based on input from operational metrics 502 and 503. Here, the time to contact service desk (Q5) is impacted by the percent of tickets not closed within 5 days (P), and analyst knowledge skill level (S). An r value of −8.875 for P is used with an r value of 0.646 for S, and thus the regression equation can be expressed as:

Q5=0.855−0.612*P+0.0851*K

Where: S=0.00812424; R-Sq=92.0%; and R-Sq (adj)=90.1%

FIG. 5b shows a prediction 510 of the transactional metric 511 (Q6—understanding of issue) based on input from operational metrics 512-514. Here, the understanding of issue (Q6) is impacted by the percent of tickets not closed within 5 days (P), analyst knowledge skill level (S), and average handle time (H). An r value of −0.805 for P, an r value of 0.883 for S, and an r value of −0.735 for H, results in the regression equation expressed as:

Q6=−0.326+0.0383*H+0.687*K−0.192*P

Where: S=0.00693911; R-Sq=94.2%; and R-Sq (adj)=91.7%

FIG. 5c shows a prediction 520 of the transactional metric 521 (Q9—appropriateness and/or accuracy of solution) based on input from operational metrics 522-525. Here, the appropriateness and/or accuracy of solution (Q9) is impacted by the percent of tickets not closed within 5 days (P), analyst knowledge skill level (S), average handle time (H), and analyst ability to resolve the issue (A). An r value of −0.901 for P an r value of 0.816 for S. an r value of −0.812 for H, and an r value of 0.683 for A results in en regression equation expressed as:

Q9=1.26−0.0357*H+0.162*K+0.0635*A+0.0635*P

Where: S=0.00582390; R-Sq=97.1%; and R-Sq (adj)=95.2%

Higher R squared (R-Sq) values can he used to measure the strength of a prediction. The best correlation is found with Q9—appropriateness and/or accuracy of solution. But by itself, simply analyzing Q9 would likely not completely predict overall customer satisfaction. Therefore, additional metrics are used.

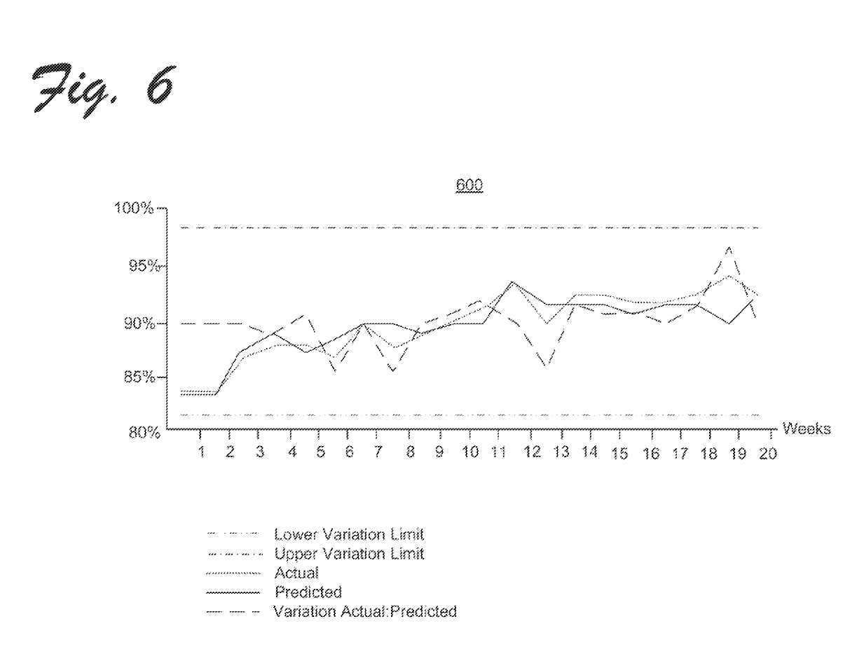

FIG. 6 is a plot 600 showing the prediction of overall customer satisfaction. It can be seen that the variance between predicted score to actual score is within about ±3% for 20 weeks in this example. During the fast four weeks, the overall customer satisfaction and significant transactional attributes are predicted using forecasted values of operational metrics. The average variation is ±1%. In this example, the regression equation for overall customer satisfaction (CSAT) can thus be expressed as:

CSAT=−0.163+0.352*Q5+0.296*Q6+0.538*Q9

Where: S=0.00635835; R-Sq=96.4%; and R-Sq (adj)=95.1%

In a test case using actual customer service data, variance between a predicted score for overall customer satisfaction using the techniques described above, and an actual score measured for customer satisfaction, was ±5% for Q5 (the time to contact service desk), ±4% for Q6 (understanding the issue), and ±3% for Q9 (appropriateness end/or accuracy of the solution).

It is noted that the techniques described above may be retrofitted and/or updated periodically to help ensure that the causal relationship between customer satisfaction and the identified business attributes remains current. The periodicity of recalibration may be based on design considerations for example, as decided by process or domain experts. In addition, users may choose to focus on input variables that can be controlled, so that the in-control variables can be addressed in response to a predicted decrease in overall customer satisfaction to achieve the desired results.

Before continuing, it should be noted that the examples described above are provided for purposes of illustration, and are not intended to be limiting. Other devices and/or device configurations may be utilized to carry out the operations described herein.

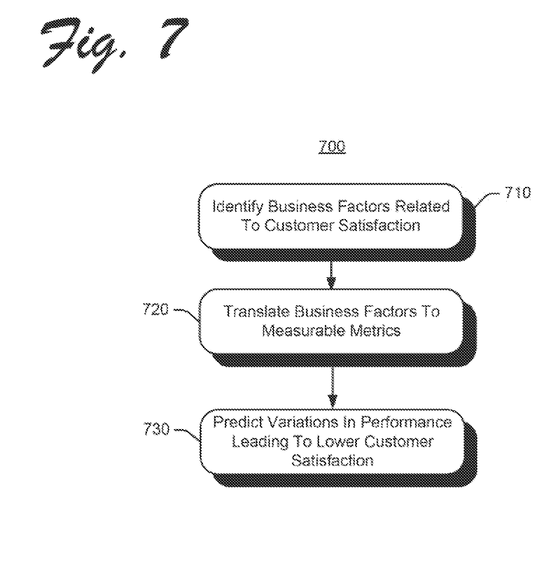

FIG. 7 is a flowchart illustrating example operations which may be implemented for predicting customer satisfaction. Operations 700 may be embodied as logic instructions on one or more computer-readable medium. When executed on a processor the logic instructions cause a general purpose computing device to be programmed as a special-purpose machine that implements the described operations. In an example, the components and connections depicted in the figures may be used.

Operation 710 includes identifying business factors related to customer satisfaction. Operation 720 includes translating the business factors to measurable metrics. Operation 730 includes predicting for a user, variations in performance leading to lower customer satisfaction based on the measurable metrics

The operations shown and described herein are provided to illustrate example implementations. It is noted that the operations are not limited to the ordering shown. Still other operations may also be implemented.

Still further operations may include automatically establishing a corrective action plan if the variations in performance exceed a threshold. Operations may also include generating an alert as part of the corrective action an in advance of a measured negative impact on customer satisfaction. Operations may also include implementing a process control as part of the corrective action plan.

In an example where transactional attributes (e.g., L3 survey questions) and operational metrics (e.g. L4 survey questions) are used, operations may further include analyzing both transactional attributes and operational metrics. Operations may also include correlating the transactional attributes and operational metrics to identify an association between the transactional attributes and operational metrics. Operations may also include predicting the transactional attributes based on the operational metrics.

Still further operations may include comparing actual scores to predicted scores. Operations may also include recalibrating operational variables over time for monitoring measurable metrics.

The operations may be implemented at least in part using an end-user interface (e.g., web-based interface). In an example, the end-user is able to make predetermined selections, and the operations described above are implemented on a back-end device to present results to a user. The user can then make further selections. It is also noted that various of the operations described herein may be automated or partially automated.

It is noted that the examples shown and described are provided for purposes of illustration and are not intended to be limiting. Still other examples are also contemplated.

1. A method for predicting customer satisfaction, the method implemented by a computing device and comprising:
identifying business factors related to customer satisfaction;
translating the business factors to measurable metrics; and
predicting for a user, variations in performance leading to lower customer satisfaction, based on the measurable metrics.

2. The method of claim 1, further comprising automatically establishing a corrective action plan if the variations in performance exceed a threshold.

3. The method of claim 2, further comprising generating an alert as part of the corrective action plan in advance of a measured negative impact on customer satisfaction.

4. The method of claim 2, further comprising implementing a process control as part of the corrective action plan.

5. The method of claim 1, further comprising analyzing both transactional attributes and operational metrics.

6. The method of claim 5, further comprising correlating the transactional attributes with the operational metrics to identify an association between the transactional attributes and the operational metrics.

7. The method of claim 5, further comprising predicting the transactional attributes based on the operational metrics.

8. The method of claim 1, further comprising comparing actual scores to predicted scores to assess performance over time.

9. The method of claim 1, recalibrating the business factors over time for monitoring customer satisfaction.

10. A system for predicting customer satisfaction, the system storing machine readable instructions on a computer readable medium and executed by a processor to:
identify business factors impacting customer satisfaction;
translate the business factors to measurable metrics; and
output predictions of variations in performance leading to lower customer satisfaction, based on the measurable metrics.

11. The system of claim 10, wherein machine readable instructions are further executed to analyze both transactional attributes and operational metrics.

12. The system of claim 10, wherein machine readable instructions are further executed to correlate transactional attributes and operational metrics and identify an association between the transactional attributes and operational metrics.

13. The system of claim 10, wherein machine readable instructions are further executed to predict transactional attributes based on operational metrics.

14. The system of claim 10, wherein machine readable instructions are further executed to compare actual scores to predicted scores.

15. The system of claim 10, wherein machine readable instructions are further executed to recalibrate operational variables over time for monitoring measurable metrics.
